(19) United States
(12) Patent Application Publication
(10) Pub. No.: US 2007/0290960 A1
(43) Pub. Date: Dec. 20, 2007

(54) Light source driving circuit and method

(75) Inventors: Du-Chang Heo, Suwon-si (KR); Sung-Soo Park, Suwon-si (KR); Yong-Chan Keh, Seoul (KR); Jin-Wook Kwon, Suwon-si (KR)

Correspondence Address: CHA & REITER, LLC, 210 ROUTE 4 EAST STE 103, PARAMUS, NJ, 07652, US

(73) Assignee: Samsung Electronics CO.; LTD

(21) Appl. No.: 11/811,164

(22) Filed: Jun. 8, 2007

(30) Foreign Application Priority Data
Jun. 19, 2006 (KR) 2006-55054
Sep. 25, 2006 (KR) 2006-92840

(51) Int. Cl. G09G 3/32

(52) U.S. Cl. 345/82

(57) ABSTRACT

A light source driving circuit and method is provided. The light source driving circuit includes a light source for outputting light, a light receiving unit for detecting a portion of the light output from the light source, a switching unit for controlling the supply of a source voltage according to an operation control signal, a constant current source for supplying a current corresponding to a threshold current to the light source according to the control of the switching unit, and an automatic power controller for controlling a driving current of the light source in response to an external modulation signal. Accordingly, by supplying a current corresponding to a threshold current of a green laser by means of a switching operation according to an operation control signal for a set time before a modulation signal of the green laser is input, a turn-on delay of the green laser can be reduced.

### CLAIM OF PRIORITY

This application claims the benefit of the earlier filing date, under 35 U.S.C. §119, to those patent applications entitled “Light Source Driving Circuit and Method,” filed in the Korean Intellectual Property Office on Jun. 19 and Sep. 25, 2006 and assigned Serial Nos. 2006-55054 and 2006-92840, respectively, the contents of which are incorporated herein by reference.

### BACKGROUND OF THE INVENTION

1. Field of the Invention

The present invention relates to a light source driving circuit, and in particular, to a light source driving circuit and method for constantly maintaining a light output regardless of a change of an ambient temperature or deterioration of a light source.

2. Description of the Related Art

Display devices using a laser light source have been suggested to use laser light sources of red, blue and green as the light source due to modulation easiness of image signals, the improvement of color reproduction, and an increase of brightness. In particular, when a semiconductor laser is used as a display light source, power of a light output varies due to a change of an ambient temperature or deterioration of the light source, causing a decrease of color quality and brightness of display devices. Thus, an apparatus for constantly maintaining the light output power of a light source, i.e., an automatic light output control circuit, is necessarily required.

Such a display device requires laser light sources of red (640 nm), green (532 nm), and blue (450 nm). At present, high-power lasers emitting wavelengths of 640 nm (red) and 450 nm (blue) is available. An example of high-power lasers emitting a wavelength of 532 nm (green) is a Diode Pumped Solid State (DPSS) laser. The DPSS laser oscillates by pumping Neodymium doped Yttrium Aluminum Garnet (Nd:YAG), Neodymium doped Yttrium Orthovanadate (Nd:YVO4), Neodymium doped Yttrium Lithium Fluoride (Nd:YLF), Ytterbium doped YAG (Yb:YAG), and Thulium doped YAG (Tm:YAG), which are solid-state laser media. The DPSS laser is increasingly used for industrial use such as marking, cutting, and the like, and has recently been developed as a display light source due to its high efficiency and high power characteristics with a small size.

Since the output power of a semiconductor laser varies significantly due to temperature, in order to stabilize light output power, a light output of the semiconductor laser must be constantly maintained based on a current detected by a photo diode The light output power emitted to the rear of a laser diode chip is detected by installing the photo diode in the rear of the laser diode chip. That is, in order to constantly maintain the light output, a driving circuit having an Automatic Power Control (APC) function is used. An existing driving circuit of a laser diode will now be schematically described with reference to Korean Patent Publication No. 2005-54792 (Title: Driving Circuit of Laser Diode Using Photo Diode), the contents of which are incorporated by reference.

FIG. 1 is a circuit diagram of an existing driving circuit 100 of a laser diode LD.

Referring to FIG. 1, when an operation voltage V_{b} of around 5 volts (V) is applied to the laser diode driving circuit 100, the operation voltage V_{b} is stabilized by a parallel RC circuit 110 in which a first resistor R1 and a first capacitor C1 are connected in parallel, and provided to an APC circuit 120. An operation of the APC circuit 120 will now be described.

In the APC circuit 120, a constant voltage is supplied to first and second transistors Q1 and Q2 due to the breakdown voltage (4.3 V) of a zener diode ZD, and if a current Iₘ flowing through the laser diode LD decreases due to a decrease of output power (a light output) according to an increase of a temperature when the laser diode LD operates, a base current I_{b1} of the first transistor Q1 increases as the current Iₘ decreases, and accordingly, a collector current I_{c1} of the first transistor Q1 increases.

Thus, a base current I_{b2} and a collector current I_{c2} of the second transistor Q2 increases, and since the collector current I_{c2} corresponds to an output current Iₒₚ of the laser diode LD, a light output of the laser diode LD increases, thereby increasing the current Iₘ. By repeatedly performing this process, APC of the laser diode LD can be achieved. The existing APC circuit 120 uses a method of controlling a current by means of the second transistor Q2 serially connected to the laser diode LD using a source voltage V_{cc} higher than an operation voltage Vₒₚ of the laser diode LD.

One feature is the case where a laser diode is driven using the APC circuit 120 requiring fast lasing with respect to a current is a turn-on delay of a light output.

As depicted in an operation waveform diagram of a laser diode illustrated in FIG. 2, when a green laser is emitted using an existing laser diode driving circuit, a turn-on delay of a light output occurs (referred to as (b)) until the laser diode starts lasing and a sufficient light output with respect to a green modulation signal (referred to as (a)) among RGB (Red, Green, and Blue) sequential signals is obtained, e.g., until the light output reaches 90% of P_{LD,MAX}. A laser driving current I_{LD} flows as a pre-set limitation value (I_{LD,LIM}) during an initial part of the turn-on delay, i.e., during no light output, decreases when the light output starts raising, and thereafter maintains a normal value (referred to as (c)).

Since a green laser structure is DPSS, a lasing phase is complex. It has been known that the reasons of the turn-on delay are a pumping time of a solid-state laser, a thermal lens forming time for lasing, and a second harmonic conversion delay time.

If the turn-on delay occurs, when data is recorded in an optical storage system for recording data in an optical storage medium, the data may be wrongly recorded in the optical storage medium due to a delay in data writing. In addition, the turn-on delay may cause a delay between a frame signal and a laser light output in an image display system using the laser, resulting in distortion of an image or omission of a portion of an image.

### SUMMARY OF THE INVENTION

An aspect of the present invention is to substantially solve at least the above problems and/or disadvantages. Accordingly, an aspect of the present invention is to minimize a turn-on delay of a light output by controlling a driving current of a light source corresponding to a modulation signal by means of timing control of a switching operation according to an operation control signal input from the outside.

Another aspect of the present invention is to minimize a turn-on delay and simultaneously minimize power consumed by a light source so that a light source driving circuit and method can be used for portable laser devices, and obtain a substantially constant light output regardless of temperature change or deterioration of the light source by employing an Automatic Power Control (APC) method.

A further aspect of the present invention is to modulate a light output in response to external modulation signals. That is, a modulation signal input unit is implemented to be able to perform a simple ON/OFF operation of a light source and modulate various waveforms of analog signals.

According to one aspect of the present invention, there is provided a light source driving circuit in a light source display device comprising a light receiving unit for detecting a portion of light output from a light source, the light source driving circuit comprising a switching unit for controlling the supply of a source voltage according to an operation control signal input from the outside, a constant current source for supplying a current corresponding to a threshold current to the light source according to the control of the switching unit and an automatic power controller for controlling a driving current in response to an external modulation signal so that a light output of the light source is substantially constantly maintained.

### BRIEF DESCRIPTION OF THE DRAWINGS

The above features and advantages of the present invention will become more apparent from the following detailed description when taken in conjunction with the accompanying drawing in which:

FIG. 1 is a circuit diagram of an existing driving circuit of a laser diode;

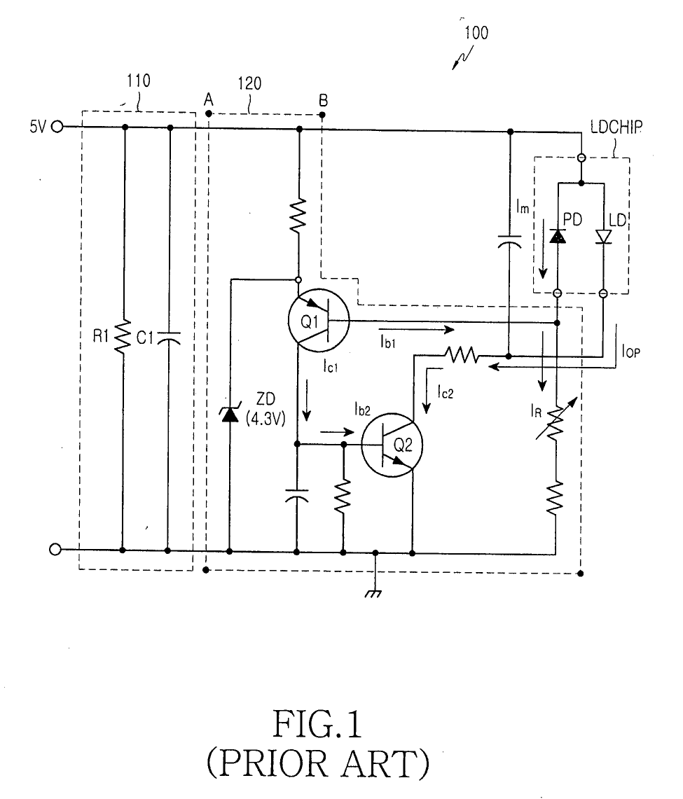

FIG. 2 is an operation waveform diagram of an existing laser diode;

FIG. 3 is a configuration diagram of a light source driving circuit according to an embodiment of the present invention;

FIG. 4 is a circuit diagram of a green laser driving circuit according to an embodiment of the present invention;

FIG. 5 is an operation waveform diagram of a green laser driving circuit according to an embodiment of the present invention;

FIG. 6 is a flowchart illustrating a green laser driving method according to an embodiment of the present invention;

FIG. 7 is a flowchart illustrating a threshold current driving method for pumping a green laser according to another embodiment of the present invention; and

FIG. 8 illustrates pumping in an Nd:YVO4+KTP crystal according to an embodiment of the present invention.

### DETAILED DESCRIPTION OF THE INVENTION

Embodiments of the present invention will be described herein below with reference to the accompanying drawings. In the drawings, the same or similar elements are denoted by the same reference numerals even though they are depicted in different drawings. For the purposes of clarity, well-known functions or constructions are not described in detail since they would obscure the invention in unnecessary detail.

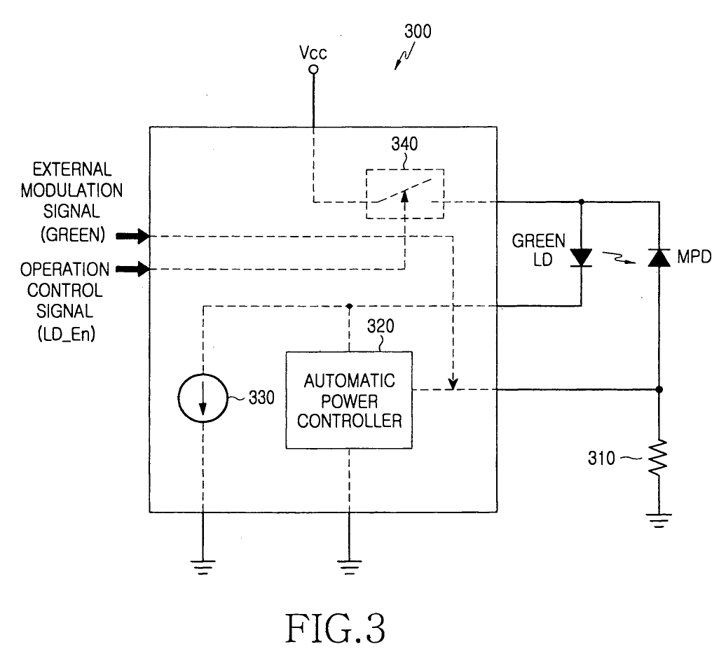

FIG. 3 is a block diagram of a light source driving circuit 300 of a green laser according to an embodiment of the present invention.

Referring to FIG. 3, the light source driving circuit 300 controls a light output of a light source to be maintained in response to a current signal detected by a light receiving unit receiving a portion of light output from the light source and a modulation signal provided by an external image controller (not shown). The modulation signal input is to increase color reproduction and the uniformity of screen brightness and in not a simple ON/OFF modulation signal but an analog modulated input signal.

A light source, as defined herein, is a device for outputting light to the front and the rear. For example, for improved color reproduction of image signals, a red laser, a blue laser, and a green laser are arranged, each emitting a laser beam proportional to the magnitude of a driving current applied to each laser.

In particular, for the green laser, a semiconductor laser implemented as a single chip has not been announced. Thus, a laser obtained by performing second harmonic conversion of a solid-state laser pumped with a semiconductor laser is generally used. For example, after a laser beam of an 808-nm wavelength is generated by applying a current to a GaAs-based semiconductor laser, a laser beam of a 1064-nm wavelength is obtained by pumping an Nd:YVO4 solid-state laser using the laser beam of the 808-nm wavelength. Thereafter, by passing the laser beam of the 1064-nm wavelength through a second harmonic generation single crystal (Potassium Titanyl Phosphate (KTP), Periodically Poled Lithium Niobate (PPLN), and the like), a green laser beam of a 532-nm wavelength can be obtained.

The light receiving unit includes a Monitor Photo Diode (MPD) for detecting a portion of light by being located in the rear of a laser diode chip. A green laser module driven by the light source driving circuit 300 has a structure in which an anode of a laser diode (LD) is connected to a cathode of the MPD, wherein an anode of the MPD is connected to a resistor R_{mpd} 310. A feedback voltage over the resistor R_{mpd} 310 generated by a detection current supplied from the anode of the MPD is provided to an automatic power controller 320.

The light source driving circuit 300 includes the automatic power controller 320 for controlling the driving current so that a light output of the LD is maintained in response to the modulation signal provided by the external image controller. The light source driving circuit 300 outputs a different type of light according to an RGB modulation signal input from the outside, and the driving current of each light source varies according to a resistance of each resistor R_{mpd} 310 and the magnitude of the modulation signal.

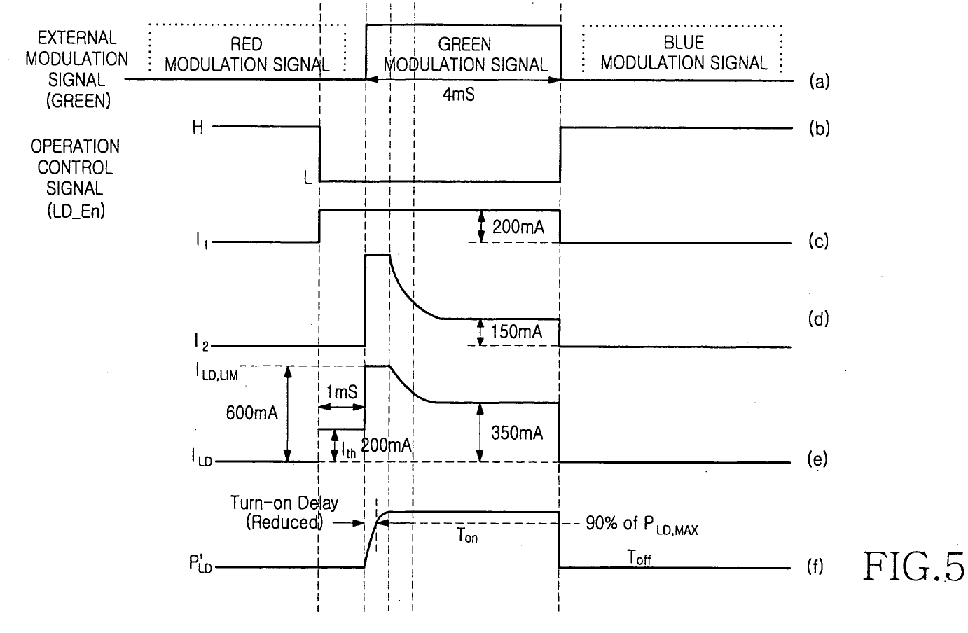

The light source driving circuit 300 also includes a switching unit 340 (represented as a switch) includes a p-channel Metal Oxide Semiconductor Field Effect Transistor (pMOSFET), (see FIG. 5) which is a switching element, to control the supply of a source voltage V_{cc} according to an operation control signal LD_En input and a constant current source 330 for supplying a substantially constant current to the green laser according to a switching operation (ON/OFF) of the switching unit 340. The substantially constant current source 330 is additionally connected to the automatic power controller 320 to reduce the turn-on delay of a light output of the green laser and operates as an ON/OFF switch by controlling the switching unit 340.

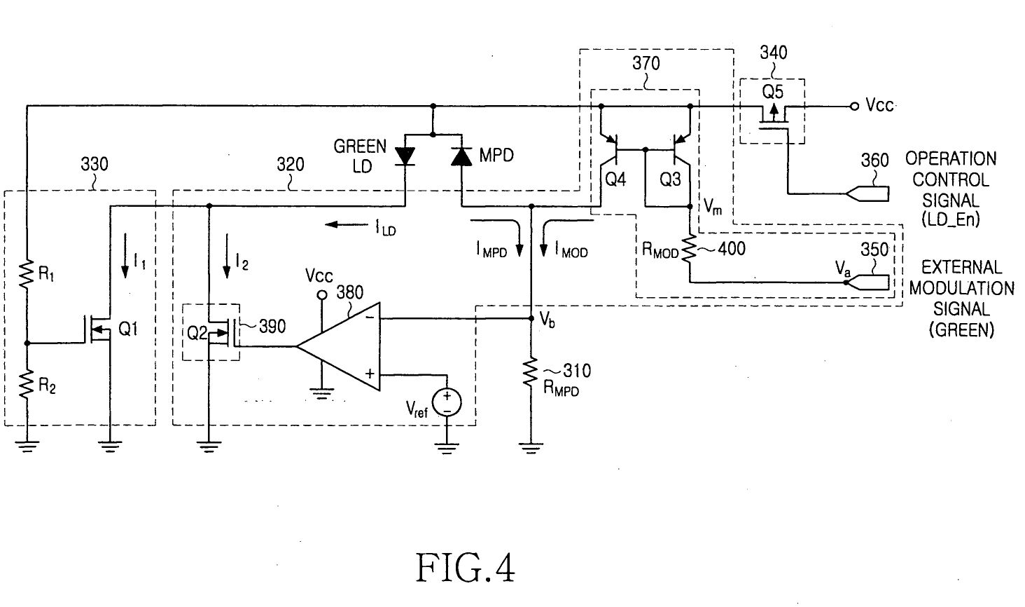

FIG. 4 is a circuit diagram of a green laser driving circuit 300 according to an embodiment of the present invention.

Referring to FIG. 4, the automatic power controller 320 of the green laser driving circuit 300 is connected to the resistor R_{mpd} 310 so that the feedback voltage V_{b} is generated by the detection current I_{mpd} output from the MPD converting the portion of light output from the green laser to a current signal. The automatic power controller 320 includes a current mirror unit 370 outputting a modulation current in response to an external modulation signal GREEN. The current mirror unit 370 includes a resistor R_{mod} 400, which is connected to a modulation signal input unit 350 to which the external modulation signal is input, an input pMOSFET Q3, a drain and a gate of which are commonly connected to the resistor R_{mod} 400, and an output pMOSFET Q4. A source of each of the pMOSFETs Q3 and Q4 is connected to the switching unit 340, which controls the supply of the source voltage V_{cc} according to the operation control signal LD_En input to an operation control signal input unit 360, and receives the source voltage V_{cc}.

In the green laser driving circuit 300, the supply of the source voltage V_{cc} is controlled by the switching unit 340 according to the operation control signal LD_En input to the operation control signal input unit 360, and the constant current source 330 supplies a current I₁ corresponding to a threshold current of the green laser for a set time before the modulation signal GREEN is input. When the modulation signal GREEN (a voltage Vₐ) is input to the modulation signal input unit 350, the current mirror unit 370 receives the source voltage V_{cc} according to the switching operation (ON/OFF) of the switching unit 340 connected to the sources of the pMOSFETs Q3 and Q4 in response to the modulation signal GREEN and outputs a modulation current I_{mod} from the drain of the output pMOSFET Q4 as expressed in Equation 1:

I_{mod}=(Vₘ−Vₐ)/R_{mod} (1)

The maximum value of the output modulation current I_{mod} can be increased until it is equal to the output current I_{mpd} of the MPD, and in this case, generated light is not output. An operation of the current mirror unit 370 will now be described in detail. If Vₐ is 0 volts, the input pMOSFET Q3 is turned on by Vₘ, a current corresponding to (Vₘ−Vₐ)/R_{mod} flows, and the same amount of current flows to the resistor R_{mpd} 310 via the output pMOSFET Q4. Generally, since the modulation current I_{mod} is set higher than the detection current I_{mpd}, when Vₐ is 0 volts, a feedback current is supplied from I_{mod}, and I_{mpd} is 0. Thus, in this case, there is no light output. If Vₐ is equal to V_{cc}, the input pMOSFET Q3 is off, I_{mod} is 0 amperes, and thus a detection voltage over the resistor R_{mpd} 310 is generated by only I_{mpd}. In this case, a light output is maximized. If the voltage of Vₐ is around a half of V_{cc}, I_{mpd} is approximately the same as I_{mod}, and a light output is reduced to around a half of the maximum value. According to the principle described above, an analog light output in response to an analog modulation signal can be achieved.

The detection current I_{mpd} of the MPD receiving a portion of light output from the green laser and converting the light to a current signal is determined by a Direct Current (DC) characteristic of the green laser. That is, the driving current of the laser needed to obtain a desired light output is determined by the DC characteristic of the laser diode, and the output current I_{mpd} of the MPD corresponding to a portion of the light output generated when the driving current flows through the laser is also determined.

The current I_{mpd} output from the MPD generates the feedback voltage V_{b} across the resistor R_{mpd} 310, and the feedback voltage V_{b} is compared to a reference voltage V_{ref} pre-set by an error amplifier 380 of the automatic power controller 320. If the feedback is normally accomplished and APC operates, the feedback voltage V_{b} is equal to the reference voltage V_{ref} of the error amplifier 380. The resistance of the resistor R_{mpd} 310 for the feedback circuit operation is determined by Equation 2, and the light output of the green laser can be controlled according to the resistance of the resistor R_{mpd} 310.

R_{mpd}=V_{ref}/I_{mpd} (2)

In the current embodiment, the maximum value of the light output is set using the resistance of the resistor R_{mpd} 310, and the light output is adjusted by changing an input modulation voltage within the maximum value.

The modulation current I_{mod} output from the current mirror unit 370 is added to the detection current I_{mpd} output from the MPD, resulting in a voltage across the resistor R_{mpd} 310. The feedback voltage V_{b} can be obtained from the voltage drop, and a current source 390 adjusts an operation current I₂ applied to the green laser according to the feedback voltage V_{b} so that the light intensity of the green laser is constantly maintained. That is, the automatic power controller 320 controls the laser beam output of the green laser to be constantly maintained by changing the operation current I₂ applied to the green laser according to the magnitude of a feedback current provided by the laser as in the widely used APC method.

FIG. 5 is an operation waveform diagram of the green laser driving circuit 300 illustrated in FIG. 4.

Referring to FIG. 5, when the green laser outputs light in response to an input modulation signal of the green laser among RGB (Red, Green, and Blue) sequential signals, a waveform of a light output P′_{LD} repeats Tₒₙ and T_{off} in a constant period (referred to as (a)).

In the green laser driving circuit 300, according to the operation control signal LD_En input to the operation control signal input unit 360, the source voltage V_{cc} is supplied from the switching unit 340 (referred to as (b)), and according to the control of the switching unit 340, the constant current source 330 constantly supplies the current I₁ corresponding to the threshold current of the green laser (referred to as (c)). According to the modulation signal GREEN, the current source 390 supplies the operation current I₂ for APC to the green laser (referred to as (d)). A time difference between the operation control signal LD_En and the modulation signal GREEN can be changed by adjusting timing of the operation control signal LD_En. During the time difference (set time), a current corresponding to the threshold current flows through the green laser, and turn-on delay reasons can be removed by the supplied threshold current, and thus when the modulation signal GREEN is input, the green laser can respond substantially immediately to the modulation signal GREEN, thereby obtaining a light output waveform (referred to as (f) in which the turn-on delay is reduced.

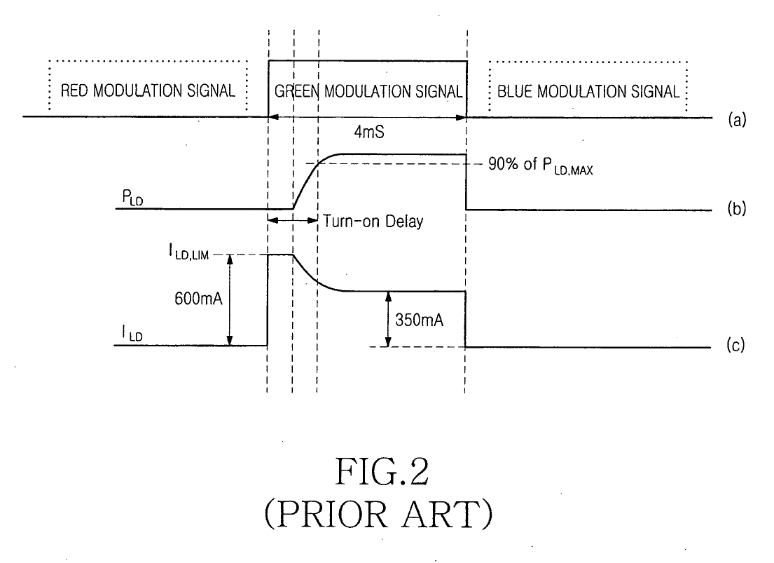

A current flowing through the green laser can be represented by adding I₁ and I₂ as referred to as (e). Compared to (c) of FIG. 2, by supplying a current corresponding to the threshold current of the green laser in the form of a staircase before the modulation signal GREEN is input, the turn-on delay of a light output can be reduced.

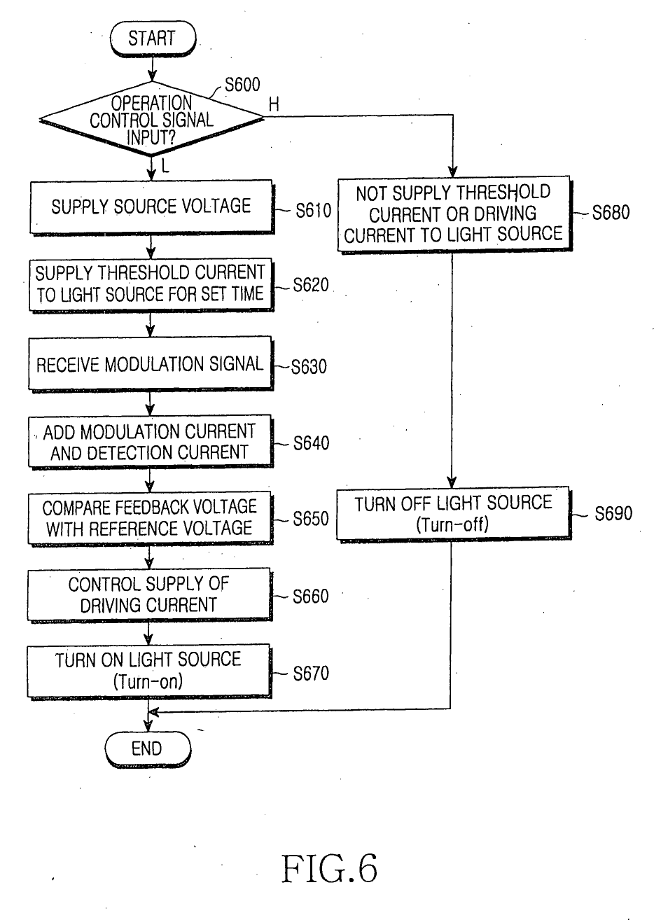

FIG. 6 is a flowchart illustrating a green laser driving method according to another embodiment of the present invention.

Referring to FIG. 6, when a green laser outputs light in response to an input modulation signal of the green laser among RGB (Red, Green, and Blue) sequential signals, a waveform of a light output P′_{LD} repeats Tₒₙ and T_{off} in a constant period.

If the operation control signal LD_En input to the operation control signal input unit 360 is a low level in step S600, the source voltage V_{cc} is supplied from the switching unit 340 in step S610, and the constant current source 330 starts supplying the threshold current (around 200 mA) of the green laser to the green laser in step S620. In this case, during a pre-set time (around 1 msec), the modulation signal GREEN of the green laser must maintain the low level, and the light output must maintain 0.

After the pre-set time from the initial supply of the source voltage V_{cc}, the modulation signal GREEN is input in step S630, and the green laser starts generating the light output in response to the modulation signal GREEN.

The MPD outputs the detection current I_{mpd} by converting a portion of light output from the green laser to a current signal. The detection current I_{mpd} is added to the modulation current I_{mod} output from the current mirror unit 370 in step S640, resulting in a voltage drop across the resistor R_{mpd} 310, and the error amplifier 380 compares the feedback voltage V_{b} across resistor R_{mpd} 310 to the reference voltage V_{ref} in step S650.

According to the comparison result, the current source 390 controls the operation current I₂ supplied to the green laser in step S660, and by adding the operation current I₂ to the threshold current I₁ flowing for the pre-set time (around 1 msec), the green laser is driven, and therefore, a turn-on delay of the light output is reduced, and green laser light is constantly output (turn-on state) in response to the external modulation signal GREEN in step S670. If the operation control signal LD_En input to the operation control signal input unit 360 is a high level in step S600, transistor Q5 of the switching unit 340 is off, the source voltage V_{cc} is not supplied to the green laser driving circuit 300, the driving current I_{LD} is not supplied to the green laser in step S680, and green laser light is not output (turn-off state) in step S690.

Consequently, the green laser driving circuit 300 supplies a current corresponding to the threshold current of the green laser from the constant current source 330 for an operation time of the switching unit 340 according to the operation control signal LD_En input to the operation control signal input unit 360 and reduces the turn-on delay by controlling the driving current of the green laser in response to the modulation signal GREEN.

Comparing P′_{LD} (step (f) of FIG. 5) that is a green laser light output waveform according to an embodiment of the present invention to P_{LD} (step (b) of FIG. 2) that is a green laser light output waveform according to an existing method, it can be seen that the turn-on delay is significantly reduced.

Compared to the existing APC method, since the threshold current additionally flows for the set time in accordance with the principles of the present invention, power consumption increases. When the green laser is driven according to the modulation signal GREEN while the threshold current continuously flows through the green laser as a DC current, the turn-on delay can be reduced. However, in this case, power consumption due to the DC current is too high to be applied to portable laser devices. Thus, by turning the source voltage V_{cc} ON/OFF by providing the operation control signal LD_En to the switching unit 340, i.e., by additionally supplying the threshold current for only the set time, additional power consumption needed to reduce the turn-on delay can be minimized.

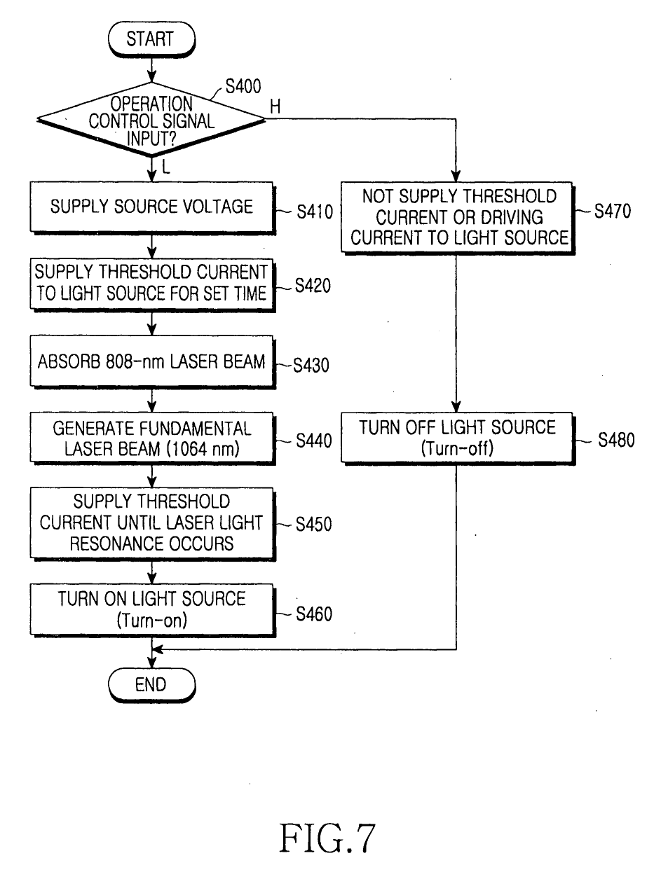

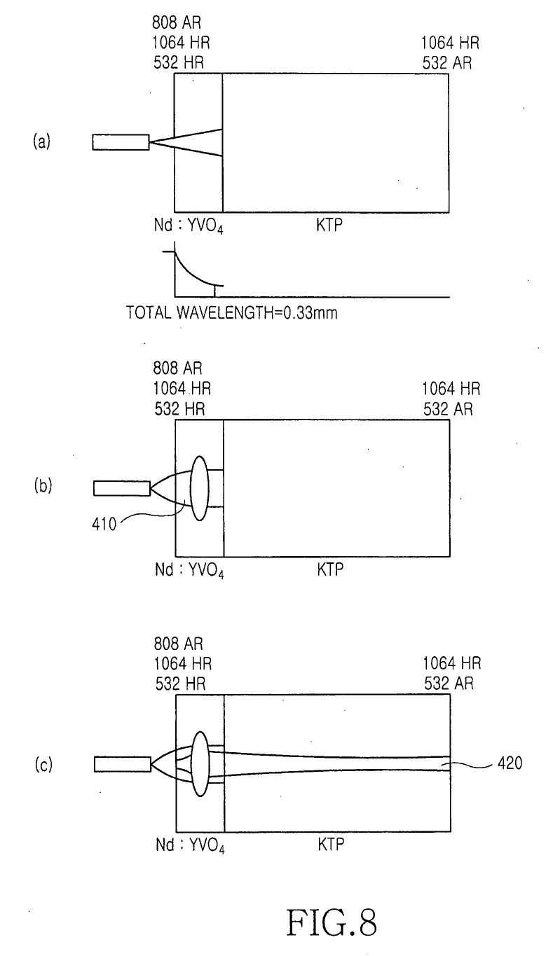

FIG. 7 is a flowchart illustrating a threshold current driving method for pumping a green laser according to another embodiment of the present invention. FIG. 8 illustrates pumping in an Nd:YVO4+KTP crystal according to another embodiment of the present invention.

Referring to FIG. 7, if the operation control signal LD_En input to the operation control signal input unit 360 is a low level in step S400, the source voltage V_{cc} is supplied from the switching unit 340 in step S410, and the constant current source 330 starts supplying the threshold current (around 200 mA) of the green laser to the green laser in step S420. In this case, during a pre-set time (around 1 msec), the modulation signal GREEN of the green laser must maintain the low level, and no light output is provided.

The green laser receives the threshold current from the constant current source 330, absorbs a laser beam of 808 nm from an Nd:YVO4 laser in step S430 (referred to as (a) of FIG. 8), generates a fundamental-wave laser beam of 1064 nm by pumping the laser beam of 808 nm in a pumping area 410 of an 808-nm non-reflective film coated Nd:YVO4 laser medium in step S440 (referred to as (b) of FIG. 8), and forms a thermal lens to transmit all the fundamental-wave laser beam of 1064 nm in reality.

In a KTP crystal coated with a fundamental-wave laser beam (1064 nm) non-reflective film and a film having high reflectivity on a second harmonic laser beam (532 nm), the fundamental-wave laser beam (1064 nm) pumped from the Nd:YVO4 laser medium is optically transmitted, and the transmitted laser beam is supplied for a set time in step S450 (referred to as (c) of FIG. 8) until laser resonance occurs due to the emission of the transmitted laser beam. That is, the resonance of light causes a resonance area 420 to be formed by reflecting the pumped fundamental-wave laser beam to the angle of reflection corresponding to the incidence angle.

When the modulation signal GREEN is input after the set time from the supply of the source voltage V_{cc}, the green laser outputs the second harmonic laser beam (532 nm) converted from an area of passing and resonating the fundamental-wave laser beam (1064 nm) pumped from the laser medium in response to the external modulation signal GREEN.

The MPD outputs the detection current I_{mpd} by converting a portion of light output from the green laser to a current signal. The detection current I_{mpd} is added to the modulation current I_{mod} output from the current mirror unit 370, resulting in a voltage drop across resistor R_{mpd} 310, and the error amplifier 380 compares the feedback voltage V_{b} across resistor R_{mpd} 310 to the reference voltage V_{ref}.

According to the comparison result, the current source 390 controls the operation current I₂ supplied to the green laser, and by adding the operation current I₂ and the threshold current I₁ flowing for the pre-set time (around 1 msec), the green laser is driven, and therefore, a turn-on delay of the light output is reduced, and green laser light is constantly output (turn-on state) in response to the external modulation signal GREEN in step S460. When the operation control signal LD_En input to the operation control signal input unit 360 is a high level in step S400, transistor Q5 of the switching unit 340 is off, the source voltage V_{cc} is not supplied to the green laser driving circuit 300, the driving current I_{LD} is not supplied to the green laser in step S470, and green laser light is not output (turn-off state) in step S480.

Consequently, the green laser driving circuit 300 supplies a current corresponding to the threshold current of the green laser from the constant current source 330 for an operation time of the switching unit 340 according to the operation control signal LD_En input to the operation control signal input unit 360 and reduces the turn-on delay by controlling the driving current of the green laser in response to the modulation signal GREEN.

Thus, by turning the source voltage V_{cc} ON/OFF by providing the operation control signal LD_En to the switching unit 340, i.e., by additionally supplying the threshold current for only the set time, additional power consumption needed to reduce the turn-on delay can be minimized.

As described above, according to the present invention, by supplying a current corresponding to a threshold current of a green laser for a set time before a modulation signal of the green laser is input, a turn-on delay of the green laser can be reduced.

By reducing the turn-on delay of the green laser, a delay in data writing can be prevented in an optical storage system recording data in an optical storage medium, thereby reducing the probability of wrongly recording data in the optical storage medium. In addition, by preventing a delay between a frame signal and a laser light output in an image display system using a laser, distortion of an image or omission of a portion of an image can be prevented.

Since the threshold current is additionally supplied to the green laser for the set time in order to reduce the turn-on delay, power consumption is increased. However, by supplying the threshold current for only a necessary time by turning the threshold current on/off using an operation control signal LD_En, additional power consumption can be minimized.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A light source driving circuit in a light source display device including a light receiving unit for detecting a portion of light output from a light source, the light source driving circuit comprising:
a switching unit for controlling the supply of a source voltage according to an operation control signal;
a constant current source for supplying a current corresponding to a threshold current to the light source according to the control of the switching unit; and
an automatic power controller for controlling a driving current in response to an external modulation signal so that a light output of the light source is constantly maintained.

2. The light source driving circuit of claim 1, wherein the constant current source supplies a threshold current of the light source during an operation time of the switching unit.

3. The light source driving circuit of claim 1, wherein the constant current source comprises a Metal Oxide Semiconductor Field Effect Transistor (MOSFET).

4. The light source driving circuit of claim 1, wherein the switching unit comprises a p-channel MOSFET (pMOSFET).

5. The light source driving circuit of claim 1, wherein the automatic power controller comprises:
a current mirror unit for outputting a modulation current in response to the modulation signal, wherein said automatic power controller is connected to a resistor causing a voltage drop due to a current obtained by adding the modulation current output from the current mirror unit and a current output from the light receiving unit.

6. The light source driving circuit of claim 5, wherein the resistor sets the maximum light output according to its resistance, wherein a light output is adjusted by the external modulation signal.

7. The light source driving circuit of claim 5, wherein the automatic power controller further comprises:
an error amplifier for comparing an output voltage of the resistor with a pre-set reference voltage; and
a current source for adjusting a driving current supplied to the light source according to an output signal of the error amplifier.

8. The light source driving circuit of claim 5, wherein the current mirror unit comprises:
a modulation signal input unit through which the modulation signal is input;
a resistor causing a voltage drop in response to the modulation signal input from the modulation signal input unit;
an input pMOSFET, a drain and a gate of which are commonly connected to the resistor; and
an output pMOSFET,
wherein the source voltage is supplied to resources of the input and output pMOSFETs.

9. The light source driving circuit of claim 1, wherein the light source comprises a green laser.

10. The light source driving circuit of claim 9, wherein the green laser generates a second harmonic wave by passing a solid-state laser pumped using a semiconductor laser through a single crystal.

11. The light source driving circuit of claim 1, wherein the light receiving unit comprises a monitor photo diode.

12. A light source driving method in a light source display device including a light receiving unit for detecting a portion of light output from a light source, the light source driving method comprising:
receiving an operation control signal;
supplying a source voltage when the operation control signal is a low level;
supplying a threshold current from a constant current source to the light source for a set time according to the operation control signal;
receiving a modulation signal of the light source;
adding a modulation current according to the modulation signal and a detection current output from the light receiving unit;
comparing a voltage drop generated by the added current to a reference voltage;
controlling a driving current of the light source according to the comparison result; and
outputting light from the light source.

13. The light source driving method of claim 12, further comprising:
not supplying the threshold current or the driving current from the constant current source to the light source for the set time when the operation control signal is a high level,.

14. A current driving method for pumping a green laser in a green laser driving circuit, the current driving method comprising:
receiving an operation control signal;
supplying a source voltage to the green laser driving circuit, when the operation control signal is a low level;
supplying a threshold current from a constant current source of the green laser driving circuit to the green laser according to the operation control signal;
absorbing an 808-nm laser beam in the green laser;
generating a fundamental-wave laser beam from a laser medium of the green laser by means of the 808-nm laser beam; and
supplying the threshold current until laser beam resonance is formed by passing the fundamental-wave laser beam generated from the laser medium through a nonlinear crystal.

15. The current driving method of claim 14, wherein the constant current source supplies the threshold current to the green laser according to the operation control signal.

16. The current driving method of claim 15, further comprising:
after the constant current source supplies the threshold current for a pre-set time, the green laser converting the fundamental-wave laser beam from the nonlinear crystal to a second harmonic laser beam and outputting the second harmonic laser beam.

17. The current driving method of claim 16, wherein a light output of the green laser can be adjusted according to a resistance of a resistor of the green laser driving circuit.

18. The current driving method of claim 14, further comprising:
not supplying the threshold current or the driving current from the constant current source to the green laser for the set time when the operation control signal is a high level.

19. The current driving method of claim 14, wherein the green laser is a semiconductor laser emitting a constant wavelength of light or a wavelength variable solid-state laser.

20. The current driving method of claim 19, wherein the solid-state laser is a material made of a laser medium which is selected from the group consisting of: Neodymium doped Yttrium Aluminum Garnet (Nd:YAG), Neodymium doped Yttrium Lithium Fluoride (Nd:YLF), Neodymium doped Yttrium Orthovanadate (Nd:YVO4), and Ytterbium doped YAG (Yb:YAG).

21. The current driving method of claim 19, wherein the nonlinear crystal is a nonlinear material selected from the group consisting of: Potassium Titanyl Phosphate (KTP), Periodically Poled Lithium Niobate (PPLN), Lithium Triborate (LBO), Beta Barium Borate (BBO), and Potassium Niobate (KN).

22. The current driving method of claim 14, wherein the nonlinear crystal is a nonlinear material converting the fundamental-wave laser beam to a third harmonic laser beam and outputting the third harmonic laser beam.

23. The current driving method of claim 14, wherein the green laser driving circuit comprises an Automatic Power Control (APC) circuit for controlling a light output of the green laser to be maintained by changing the driving current applied to the green laser.
